(19) United States
(12) Patent Application Publication
(10) Pub. No.: US 2015/0314230 A1
(43) Pub. Date: Nov. 5, 2015

(54) ABSORBENT SOLUTION BASED ON AMINES BELONGING TO THE N-ALKYLHYDROXYPIPERIDINE FAMILY AND METHOD FOR REMOVING ACID COMPOUNDS FROM A GASEOUS EFFLUENT WITH SUCH A SOLUTION

(71) Applicant: IFP ENERGIES NOUVELLES, Rueil-Malmaison (FR)

(72) Inventors: Julien GRANDJEAN, Lyon (FR); Bruno DELFORT, Paris (FR)

(21) Appl. No.: 14/649,925

(22) PCT Filed: Nov. 25, 2013
(86) PCT No.: PCT/FR2013/052848

§ 371 Date: Jun. 5, 2015

(30) Foreign Application Priority Data
Dec. 7, 2012 (FR) 1203330

(51) Int. Cl. B01D 53/14; B01D 53/78; C10L 3/10; B01D 53/40

(52) U.S. Cl. CPC B01D 53/1493; B01D 53/1456; B01D 53/1468; B01D 53/40; B01D 53/78; C10L 3/104; B01D 2252/20484; C10L 2290/44; C10L 2290/541

(57) ABSTRACT

The invention relates to an absorbent solution comprising water and at least one amine belonging to the N-alkyl-hydroxypiperidine family and to a method implementing this solution for removing acid compounds contained in a gaseous effluent.

### FIELD OF THE INVENTION

The present invention relates to the field of gaseous effluent deacidizing methods. The invention is advantageously applied for treating gas of industrial origin and natural gas.

### BACKGROUND OF THE INVENTION

Absorption methods using an aqueous amine solution are commonly used for removing acid compounds (notably CO₂, H₂S, COS, CS₂, SO₂ and mercaptans) present in a gas. The gas is deacidized by contacting with the absorbent solution, then the absorbent solution is thermally regenerated. For example, document U.S. Pat. No. 6,852,144 describes a method of removing acid compounds from hydrocarbons. The method uses a water-N-methyldiethanolamine or water-triethanolamine absorbent solution with a high proportion of a compound belonging to the following group: piperazine and/or methylpiperazine and/or morpholine.

One limitation of the absorbent solutions commonly used in deacidizing applications is their insufficient H₂S absorption selectivity in relation to CO₂. Indeed, in some natural gas deacidizing cases, selective H₂S removal is sought by limiting to the maximum CO₂ absorption. This constraint is particularly important for gases to be treated already having a CO₂ content that is less than or equal to the desired specification. A maximum H₂S absorption capacity is then sought with maximum H₂S absorption selectivity in relation to CO₂. This selectivity allows to recover an acid gas at the regenerator outlet having the highest H₂S concentration possible, which limits the size of the sulfur chain units downstream from the treatment and guarantees better operation. In some cases, an H₂S enrichment unit is necessary for concentrating the acid gas in H₂S. In this case, the most selective amine is also sought. Tertiary amines such as N-methyldiethanolamine (or MDEA) or hindered secondary amines exhibiting slow reaction kinetics with CO₂ are commonly used, but their selectivities are limited to high H₂S loadings.

Another limitation of the absorbent solutions commonly used in total deacidizing applications is too slow CO₂ or COS capture kinetics. In cases where the desired CO₂ or COS specifications level is very high, the fastest possible reaction kinetics is sought so as to reduce the height of the absorption column. This equipment under pressure, typically between 40 bars and 70 bars, represents a significant part of the investment costs of the process.

Whether seeking maximum CO₂ and COS capture kinetics in a total deacidizing application, or minimum CO₂ capture kinetics in a selective application, it is always desirable to use an absorbent solution having the highest cyclic capacity possible. This cyclic capacity, denoted by Δα, corresponds to the loading difference (α designates the number of moles of absorbed acid compounds n_{acid gas} per kilogram of absorbent solution) between the absorbent solution fed to the absorption column and the absorbent solution discharged from the bottom of said column. Indeed, the higher the cyclic capacity of the absorbent solution, the more limited the absorbent solution flow rate required for deacidizing the gas to be treated. In gas treatment methods, reduction of the absorbent solution flow rate also has a great impact on the reduction of investments, notably as regards absorption column sizing.

Another essential aspect of industrial gas or fumes treatment operations using a solvent remains the regeneration of the separation agent. Regeneration through expansion and/or distillation and/or entrainment by a vaporized gas referred to as “stripping gas” is generally considered depending on the absorption type (physical and/or chemical).

Another limitation of the absorbent solutions commonly used today is the energy consumption necessary for solvent regeneration, which is too high. This is particularly true in cases where the acid gas partial pressure is low. For example, for a 30 wt. % 2-aminoethanol (or monoethanolamine or ethanolamine or MEA) aqueous solution used for post-combustion CO₂ capture in thermal power plant fumes, where the CO₂ partial pressure is of the order of 0.12 bar, the regeneration energy represents approximately 3.7 GJ per ton of CO₂ captured. Such an energy consumption represents a significant operating cost for the CO₂ capture process.

It is well known to the person skilled in the art that the energy required for regeneration by distillation of an amine solution can be divided into three different items: the energy required for heating the solvent between the top and the bottom of the regenerator, the energy required for lowering the acid gas partial pressure in the regenerator by vaporization of a stripping gas, and the energy required for breaking the chemical bond between the amine and the CO₂.

These first two items are proportional to the absorbent solution flows to be circulated in the plant in order to achieve a given specification. In order to decrease the energy consumption linked with the regeneration of the solvent, the cyclic capacity of the solvent is therefore once again preferably maximized.

The last item relates to the energy required for breaking the bond created between the amine used and the CO₂. To decrease the energy consumption linked with the regeneration of the absorbent solution, the binding enthalpy ΔH is thus preferably minimized. However, it is not easy to find a solvent with a high cyclic capacity and a low reaction enthalpy. The best absorbent solution from an energy point of view therefore is the one allowing to reach the best compromise between a high cyclic capacity Δα and a low binding enthalpy H.

The chemical stability of the absorbent solution is also an essential issue in gas deacidizing and treatment processes. Degradation resistance is a limitation for the commonly used absorbent solutions, notably under regeneration conditions at temperatures ranging between 160° C. and 180° C. considered in CO₂ capture processes. These conditions would allow the CO₂ to be recovered at a pressure ranging between 5 and 10 bars, thus enabling to save energy on the compression of the CO₂ captured with a view to the transport and storage thereof.

It is thus difficult to find compounds or a family of compounds allowing the various deacidizing processes to operate at lower operating costs (including the regeneration energy) and investment costs (including the cost of the absorption column).

It is well known to the person skilled in the art that tertiary amines have slower CO₂ capture kinetics than little-hindered primary or secondary amines. On the other hand, tertiary amines have instantaneous H₂S capture kinetics, which allows selective H₂S removal based on distinct kinetic performances.

Among the applications of these tertiary amines, U.S. Pat. No. 4,483,333 describes a method of selective absorption of acid gases by an absorbent containing a tertiary alkanolamine or a tertiary aminoether alcohol whose nitrogen is included in a heterocycle.

Document WO-2009/1,105,586 A1 describes an aqueous solution and a method for absorbing carbon dioxide from a gas, this aqueous solution containing at least one amine represented by the general formula below:

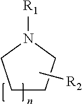

with n=1 or 2, R₁ is an alkyl or hydroxyalkyl group and R₂ in position 2 or 3 represents a hydrogen, an alkyl or hydroxyalkyl group, provided that at least one of groups R₁ and R₂ is a hydroxyalkyl group.

More particularly, one compound of interest is N-methyl-2-hydroxymethylpiperidine, whose capture capacities and absorption rate are described. However, this document does not describe the performances of this molecule in terms of selective H₂S removal from a gas containing H₂S and CO₂.

The inventors have discovered that tertiary alkanolamines whose nitrogen is included in a heterocycle are not equivalent in terms of performance for use in absorbent solution formulations for acid gas treatment in an industrial process.

Some molecules of heterocyclic tertiary alkanolamine type have insufficient performances, notably as regards the selective removal of H₂S from a gas containing H₂S and CO₂. A contrario, other molecules allow to improve the H₂S absorption selectivity in relation to reference tertiary amines, such as methyldiethanolamine. These molecules also exhibit particularly high acid gas absorption performances, notably CO₂, and chemical stability.

The object of the present invention is the use of particular molecules belonging to the heterocyclic tertiary alkanolamine family exhibiting optimum performances for CO₂ capture capacity, selective H₂S removal and thermal stability within the context of gas deacidizing. These molecules meet the general definition of N-alkyl-hydroxypiperidines. These heterocyclic tertiary alkanolamines exhibit the specific feature of having a single hydroxyl group directly attached to one of the carbon atoms of the heterocycle, this heterocycle being a piperidine ring. More precisely, these molecules are N-alkyl-3-hydroxypiperidines and N-alkyl-4-hydroxypiperidines meeting general formula (I).

The N-alkyl-hydroxypiperidines according to the invention are notably distinguished from document WO-2009/1,105,586 A1 wherein group R₂ can by no means be a hydroxyl group.

Another object of the invention relates to a method of removing acid compounds contained in a gaseous effluent, wherein an acid compound absorption stage is carried out by contacting the effluent with the absorbent solution according to the invention.

Using the N-alkyl-hydroxypiperidine compounds according to the invention allows to obtain higher acid gas absorption capacities than the reference amines. This performance is increased due to a higher basicity.

Besides, the compounds according to the invention have a higher H₂S selectivity than the reference amines.

Furthermore, in the particular case of a natural gas treatment application where the absorbent solution contains a compound according to the invention in admixture with a primary or secondary amine, the invention allows the COS and CO₂ absorption kinetics to be accelerated in relation to a MDEA solution containing the same proportion of primary or secondary amine. This COS and CO₂ absorption kinetics gain allows to save on the cost of the absorption column in cases where removal of this compound at a high level of specifications (1 ppm) is required.

### SUMMARY OF THE INVENTION

In general terms, the present invention relates to an absorbent solution for removing acid compounds contained in a gaseous effluent, comprising:

a—water,
b—at least one compound selected from the N-alkyl-3-hydroxypiperidine and N-alkyl-4-hydroxypiperidine group with general formula (I):

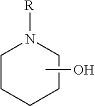

wherein the hydroxyl radical can be in position 3 or in position 4 with respect to the nitrogen atom of the piperidine ring, and R is an alkyl radical containing one to six carbon atoms, preferably one to three carbon atoms.

According to the invention, the nitrogen compound can be selected from among the following compounds, meeting by way of non limitative example the above general formula (I):

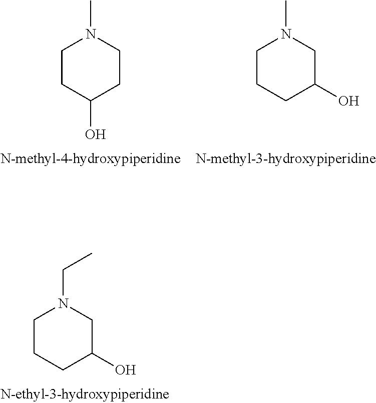

According to the invention, the solution can comprise between 10 and 90 wt. % of said nitrogen compound, preferably between 20 and 60 wt. %, more preferably between 25 and 50 wt. %; and the solution can comprise between 10 and 90 wt. % of water, preferably between 40 and 80 wt. %, more preferably between 50 and 75 wt. %.

According to one embodiment, the solution can comprise an additional amine, said additional amine being a tertiary amine such as methyldiethanolamine, or a secondary amine having two tertiary carbons at nitrogen alpha position, or a secondary amine having at least one quaternary carbon at nitrogen alpha position. In this case, the solution can comprise between 10 and 90 wt. % of said additional amine, preferably between 10 and 50 wt. %, more preferably between 10 and 30 wt. %.

According to another embodiment, the solution can comprise a compound containing at least one primary or secondary amine function. In this case, the solution can have a concentration of up to 30 wt. % of said compound, preferably below 15 wt. %, preferably below 10 wt. % and of at least 0.5 wt. %. The solution can have a concentration of at least 0.5 wt. % of said compound. The compound can be selected from among:
monoethanolamine,
N-butylethanolamine,
aminoethylethanolamine,
diglycolamine,
piperazine,
1-methylpiperazine,
2-methylpiperazine,
N-(2-hydroxyethyl)piperazine,
N-(2-aminoethyl)piperazine,
morpholine,
3-(methylamino)propylamine,
1,6-hexanediamine and all the diversely N-alkylated derivatives thereof such as, for example, N,N′-dimethyl-1,6-hexanediamine, N-methyl-1,6-hexanediamine or N,N′,N′-trimethyl-1,6-hexanediamine.

According to the invention, the solution can comprise a physical solvent selected from among methanol and sulfolane.

The invention also relates to a method for removing acid compounds contained in a gaseous effluent, wherein an acid compound absorption stage is carried out by contacting the effluent with the absorbent solution according to the invention.

According to the invention, the acid compound absorption stage can be carried out at a pressure ranging between 1 bar and 120 bars, and at a temperature ranging between 20° C. and 100° C.

According to one embodiment, after the absorption stage, a gaseous effluent depleted in acid compounds and an absorbent solution laden with acid compounds are obtained, and at least one stage of regenerating the absorbent solution laden with acid compounds is performed. The regeneration stage can be carried out at a pressure ranging between 1 bar and 10 bars, and at a temperature ranging between 100° C. and 180° C. The gaseous effluent can be selected from among natural gas, syngas, combustion fumes, refinery gas, acid gas from amine units, Claus tail gas, biomass fermentation gas, cement plant gas and incinerator fumes.

Finally, the method can be implemented for selective H₂S removal from a gaseous effluent comprising H₂S and CO₂.

### BRIEF DESCRIPTION OF THE FIGURES

Other features and advantages of the invention will be clear from reading the description hereafter, with reference to the accompanying figures wherein:

FIG. 1 is a block diagram of an acid gas effluent treating method,

FIG. 2 diagrammatically shows the synthesis of an N-alkyl-hydroxypiperidine according to the invention from a picoline, and

FIG. 3 diagrammatically shows the synthesis of the N-methyl-4-hydroxypiperidine according to the invention from methyl acrylate.

### DETAILED DESCRIPTION

The present invention provides an aqueous solution and a method for removing acid compounds from a gaseous effluent.

The aqueous solution according to the invention comprises at least one nitrogen compound selected from among the N-alkyl-3-hydroxypiperidine and N-alkyl-4-hydroxypiperidine group.

The molecules according to the invention can be synthesized using all the routes permitted by organic chemistry. For each molecule of the invention, some of them can be mentioned by way of non exhaustive example.

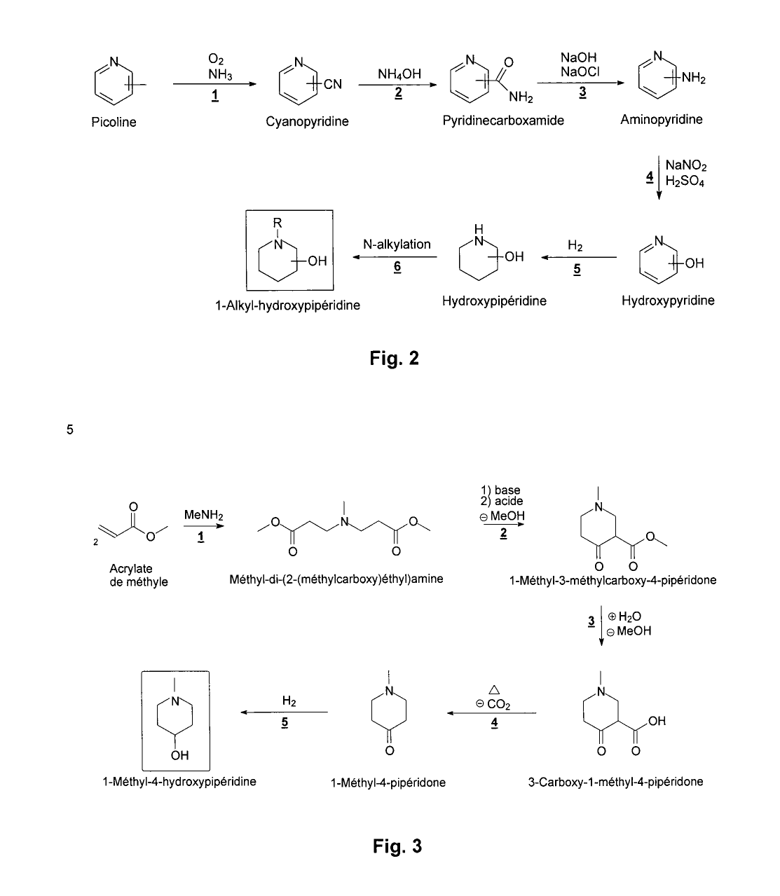

The N-alkyl-hydroxypiperidines of the invention can be synthesized using all the routes permitted by organic chemistry. By way of example, synthesis can be achieved from widely available industrial products such as 3- or 4-methylpyridines, also referred to as 3- or 4-picolines, according to a general reaction scheme illustrated by FIG. 2.

The ammoxidation reaction of the 3- or 4-picolines (reaction 1) leads to 3- or 4-cyanopyridines that are subsequently converted to 3- or 4-pyridinecarboxamides according to a basic hydrolysis (reaction 2). The 3- or 4-pyridinecarboxamides can then be converted to 3- or 4-aminopyridines in a basic medium and in the presence, for example, of sodium hypochlorite according to the reaction known as “Hofmann reaction” (reaction 3). The 3- or 4-aminopyridines can then be converted to 3- or 4-hydroxypyridines according to a diazotization reaction that is conducted in the presence of alkaline nitrite, sodium nitrite for example, followed by an acid hydrolysis (reaction 4). The 3- or 4-hydroxypyridines obtained are then subjected to aromatic ring hydrogenation (reaction 5). This well-known reaction leads to 3- or 4-hydroxypiperidines also referred to as 3- or 4-piperidinols. Finally, the 3- or 4-hydroxypiperidines are subjected to a reaction referred to as N-alkylation (reaction 6) leading to 1-alkyl-3- or 4-hydroxypiperidines. This N-alkylation reaction can take place for example by condensation of the 3- or 4-hydroxypiperidines with an alkyl halide. Preferably, this N-alkylation reaction is performed by condensation of the 3- or 4-hydroxypiperidines with either an alcohol or an aldehyde, or a ketone in the presence of hydrogen and of a suitable catalyst.

In the case of the molecules of the invention meeting the definition of N-alkyl-4-hydroxypiperidines, an advantageous synthesis route consists in carrying out the synthesis in several stages from an abundant and inexpensive industrial precursor such as methyl acrylate, according to a general reaction scheme illustrated by FIG. 3 applied here to one of the preferred molecules of the invention, 1-methyl-4-hydroxypiperidine.

Adding one mole of methylamine to 2 moles of methyl acrylate leads to methyl-di-(2-(methylcarboxy)ethyl)amine (reaction 1), which is then subjected to a cyclization reaction known as “Dieckmann reaction” so as to lead to 1-methyl-3-methylcarboxy-4-piperidone (reaction 2). This reaction is conducted in a basic medium, generally with an alkaline alcoholate, and it requires a subsequent neutralization stage. The ester function of the 1-methyl-3-methylcarboxy-4-piperidone is then hydrolyzed to an acid function so as to lead to 3-carboxy-1-methyl-4-piperidone (reaction 3). From this product, 1-methyl-4-piperidone is obtained by conducting a decarboxylation reaction according to a known procedure (reaction 4). Finally, the carbonyl function of the 1-methyl-4-piperidone is hydrogenated so as to lead to 1-methyl-4-hydroxypiperidine (reaction 5). This sequence of reactions illustrated here with methylamine as the precursor can be applied to any other primary amine in order to lead to the 1-alkyl-4-hydroxypiperidine family.

Composition of the Absorbent Solution

The absorbent solution used in the method according to the invention comprises:

a—water,
b—at least one molecule selected from the N-alkyl-3-hydroxypiperidine and N-alkyl-4-hydroxypiperidine group with general formula (I):

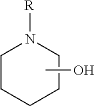

R being an alkyl radical containing one to six carbon atoms, preferably one to three carbon atoms.

The hydroxyl radical can be in position 3 or in position 4 with respect to the nitrogen atom of the piperidine ring.

For example, the absorbent solution according to the invention can comprise a nitrogen compound of general formula (I) selected from among the following compounds:

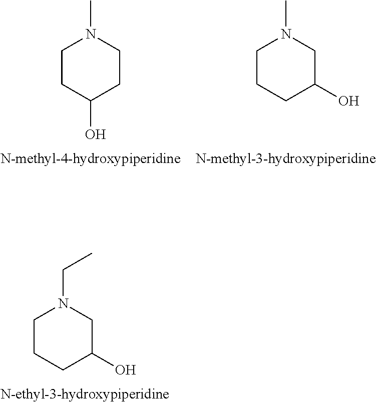

According to the invention, alkylaminopiperazine can be in variable concentration in the absorbent solution, ranging for example between 10 and 90 wt. %, preferably between 20 and 60 wt. %, more preferably between 25 and 50 wt. %.

The absorbent solution can contain between 10 and 90 wt. % water, preferably between 40 and 80 wt. % water, more preferably between 50 and 75 wt. % water.

c—According to one embodiment, the absorbent solution can also contain a tertiary amine, for example methyldiethanolamine, triethanolamine, diethylmonoethanolamine, dimethylmonoethanolamine, ethyldiethanolamine, or a secondary amine with severe steric hindrance, this hindrance being defined either by the presence of two tertiary carbons at nitrogen alpha position or by at least one quaternary carbon at nitrogen alpha position. The tertiary or severely hindered secondary amine concentration in the absorbent solution can range between 10 and 90 wt. %, preferably between 10 and 50 wt. %, more preferably between 10 and 30 wt. %.
d—According to an embodiment, the absorbent solution can contain a compound containing at least one primary or secondary amine function. For example, the absorbent solution comprises a concentration of up to 30 wt. %, preferably below 15 wt. %, preferably below 10 wt. % of said compound containing at least one primary or secondary amine function. Preferably, the absorbent solution comprises at least 0.5 wt. % of said compound containing at least one primary or secondary amine function. Said compound allows to accelerate the absorption kinetics of the COS and, in some cases, of the CO₂ contained in the gas to be treated.

A non-exhaustive list of compounds containing at least one primary or secondary amine function and that may go into the formulation is given below:
monoethanolamine,
N-butylethanolamine,
aminoethylethanolamine,
diglycolamine,
piperazine,
1-methylpiperazine,
2-methylpiperazine,
N-(2-hydroxyethyl)piperazine,
N-(2-aminoethyl)piperazine,
morpholine,
3-(methylamino)propylamine,
1,6-hexanediamine and all the diversely N-alkylated derivatives thereof such as, for example, N,N′-dimethyl-1,6-hexanediamine, N-methyl-1,6-hexanediamine or N,N′,N′-trimethyl-1,6-hexanediamine.
   e—According to an embodiment, the absorbent solution can comprise a physical solvent selected from among methanol and sulfolane.

The absorbent solution can be used for deacidizing the following gaseous effluents: natural gas, syngas, combustion fumes, refinery gas, acid gas from amine units, Claus tail gas, biomass fermentation gas, cement plant gas and incinerator fumes. These gaseous effluents contain one or more of the following acid compounds: CO₂, H₂S, mercaptans, COS, CS₂, SO₂. Combustion fumes are notably produced by the combustion of hydrocarbons, biogas, coal in a boiler or for a combustion gas turbine, for example in order to produce electricity. By way of example, the method according to the invention can be implemented in order to absorb at least 70%, preferably at least 80 or even at least 90% of the CO₂ contained in combustion fumes. These fumes generally have a temperature ranging between 20° C. and 60° C., a pressure ranging between 1 and 5 bars, and they can contain between 50 and 80% nitrogen, between 5 and 40% carbon dioxide, between 1 and 20% oxygen, and some impurities such as SOx and NOx if they have not been removed upstream from the deacidizing process. In particular, the method according to the invention is particularly well suited for absorbing the CO₂ contained in combustion fumes with a low CO₂ partial pressure, for example a CO₂ partial pressure below 200 mbar.

Method of Removing Acid Compounds from a Gaseous Effluent

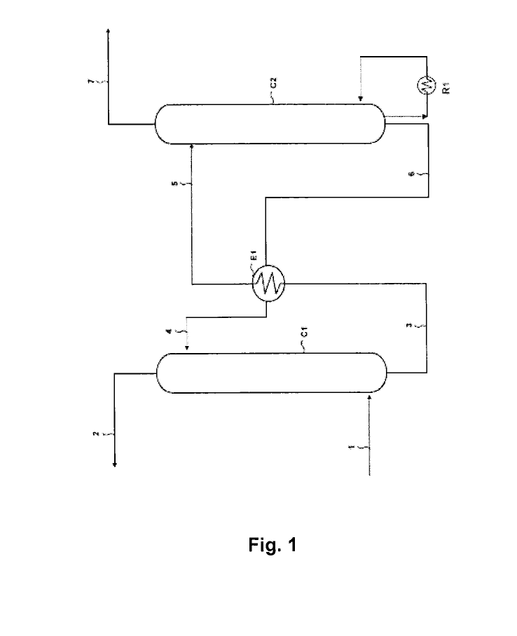

The invention also relates to a method for deacidizing a gaseous effluent from the aqueous solution according to the invention. This method is schematically implemented by carrying out an absorption stage followed by a regeneration stage, as illustrated by FIG. 1 for example.

With reference to FIG. 1, the absorption stage consists in contacting gaseous effluent 1 with absorbent solution 4. Gaseous effluent 1 is fed to the bottom of C1 and the absorbent solution is fed to the top of C1. Column C1 is provided with gas-liquid contacting means, for example a random packing, a structured packing or distillation trays. Upon contacting, the amine functions of the molecules of the absorbent solution react with the acid compounds contained in the effluent, so as to obtain a gaseous effluent depleted in acid compounds 2 discharged at the top of C1 and an absorbent solution enriched in acid compounds 3 discharged at the bottom of C1 in order to be regenerated.

The regeneration stage notably consists in heating, and optionally in expanding, the absorbent solution enriched in acid compounds in order to release the acid compounds in gas form. The absorbent solution enriched in acid compounds 3 is fed into heat exchanger E1 where it is heated by stream 6 coming from regeneration column C2. Solution 5 heated at the outlet of E1 is fed into regeneration column C2.

Regeneration column C2 is equipped with gas-liquid contacting internals such as trays, random or structured packings for example. The bottom of column C2 is fitted with a reboiler R1 that provides the heat required for regeneration by vaporizing a fraction of the absorbent solution. In column C2, under the effect of contacting the absorbent solution flowing in through 5 with the vapour produced by the reboiler, the acid compounds are released in gas form and discharged at the top of C2 through line 7. Regenerated absorbent solution 6, i.e. depleted in acid compounds, is cooled in E1, then recycled to column C1 through line 4.

The acid compound absorption stage can be carried out at a pressure in C1 ranging between 1 and 120 bars, preferably between 20 and 100 bars for natural gas treatment, preferably between 1 and 3 bars for industrial fumes treatment, and at a temperature in C1 ranging between 20° C. and 100° C., preferably between 30° C. and 90° C., or even between 30° C. and 60° C.

The regeneration stage of the method according to the invention can be carried out by thermal regeneration, optionally complemented by one or more expansion stages.

Regeneration can be carried out at a pressure in C2 ranging between 1 and 5 bars, or even up to 10 bars, and at a temperature in C2 ranging between 100° C. and 180° C., preferably between 130° C. and 170° C. Preferably, the regeneration temperature in C2 ranges between 155° C. and 180° C. in cases where the acid gases are intended to be reinjected. Preferably, the regeneration temperature in C2 ranges between 115° C. and 130° C. in cases where the acid gas is sent to the atmosphere or to a downstream treating process such as a Claus process or a tail gas treating process.

The method according to the invention can be used for deacidizing a syngas. Syngas contains carbon monoxide CO, hydrogen H₂ (generally with an Hz/CO ratio of 2), water vapour (it is generally saturated therewith at the temperature at which washing is performed) and carbon dioxide CO₂ (of the order of 10%). The pressure generally ranges between 20 and 30 bars, but it can reach up to 70 bars. It also comprises sulfur-containing (H₂S, COS, etc.), nitrogen-containing (NH₃, HCN) and halogenated impurities.

The method according to the invention can be used for deacidizing a natural gas. Natural gas is predominantly made up of gaseous hydrocarbons, but it can contain some of the following acid compounds: CO₂, H₂S, mercaptans, COS, CS₂. These acid compounds are present in greatly variable proportions, up to 40% for CO₂ and H₂S. The temperature of the natural gas can range between 20° C. and 100° C. The pressure of the natural gas to be treated can range between 10 and 120 bars. The invention can be implemented to reach specifications generally imposed on the deacidized gas, which are 2% CO₂, or even 50 ppm CO₂ so as to subsequently carry out liquefaction of the natural gas, 4 ppm H₂S, and 10 to 50 ppm volume of total sulfur.

### Example 1

### Capacity and Selectivity for H₂S Removal from a Gaseous Effluent Containing H₂S and CO₂ by N-Methyl-4-Hydroxypiperidine, N-Methyl-3-Hydroxypiperidine and N-Ethyl-4-Hydroxypiperidine Solutions

An absorption test is carried out at 40° C. on aqueous amine solutions within a perfectly stirred reactor open on the gas side.

For each solution, absorption is conducted in a 50-cm³ liquid volume by bubbling of a gas stream consisting of a mixture of nitrogen:carbon dioxide:hydrogen sulfide in a volume proportion of 89:10:1, at a flow rate of 30 NL/h for 90 minutes.

The H₂S loading obtained (α=nbr moles of H₂S/kg of solvent) and the absorption selectivity over CO₂ are measured at the end of the test.

This selectivity S is defined as follows:

$$S = \frac{{α}_{{H}_{2} S}}{{α}_{{CO}_{2}}} \times \frac{( {CO}_{2} concentration of the gas mixture )}{( {H}_{2} S concentration of the gas mixture )}$$

Under the conditions of the test described here,

$$S = 10 \times \frac{{α}_{{H}_{2} S}}{{α}_{{CO}_{2}}} .$$

By way of example, we can compare the loadings and the selectivity between a 50 wt. % N-methyl-4-hydroxypiperidine absorbent solution according to the invention, a 50 wt. % N-methyl-3-hydroxypiperidine absorbent solution according to the invention and a 49 wt. % N-ethyl-4-hydroxypiperidine absorbent solution according to the invention, a 47 wt. % methyldiethanolamine (MDEA) absorbent solution, a reference compound for selective H₂S removal in gas treatment, as well as a 50 wt. % (N-methyl-3-hydroxymethyl)piperidine absorbent solution, a heterocyclic tertiary amine mentioned in U.S. Pat. No. 4,483,833 and belonging to the general formula mentioned in document WO-2009/1,105,586, and distinct from the invention.

TABLE 1

| | | | H₂S loading | |
|---|---|---|---|---|
| Compound | Concentration | T (° C.) | (mole/kg) | Selectivity |
| MDEA | 47% | 40 | 0.16 | 6.3 |
| (N-methyl-3-hydroxymethyl)piperidine | 50% | 40 | 0.24 | 6.3 |
| (prior art) | | | | |
| N-methyl-4-hydroxypiperidine (according | 50% | 40 | 0.22 | 13.8 |
| to the invention) | | | | |
| N-methyl-3-hydroxypiperidine (according | 50% | 40 | 0.17 | 12.9 |
| to the invention) | | | | |
| N-ethyl-3-hydroxypiperidine (according | 49% | 40 | 0.18 | 15.0 |
| to the invention) | | | | |

This example illustrates the loading and selectivity gains that can be reached with an absorbent solution according to the invention, comprising 50 wt. % N-methyl-4-hydroxypiperidine or 50 wt. % N-methyl-3-hydroxypiperidine or 49 wt. % N-ethyl-4-hydroxypiperidine by comparison with the reference absorbent solution (47% MDEA). This example illustrates that heterocyclic tertiary alkanolamines are not all equivalent in terms of selectivity. Indeed, (N-methyl-3-hydroxymethyl)piperidine (second entry in Table 1) does not belong to the N-alkyl-hydroxypiperidine group, unlike the molecules of the invention. It provides no selectivity gain by comparison with the reference absorbent solution (47% MDEA).

It thus appears that the claimed molecules exhibit particular and improved performances in terms of loading and selectivity.

### Example 2

### CO₂ Absorption Rate of an Amine Formulation for a Selective Absorption Method

A comparative CO₂ absorption test is carried out with a 50 wt. % N-methyl-4-hydroxypiperidine absorbent solution according to the invention in relation to an aqueous 47 wt. % methyldiethanolamine solution.

These solutions are also compared with a 50 wt. % N-methyl-2-hydroxymethylpiperidine solution, a molecule described in document WO-2009/1,105,586 and according to the definition of U.S. Pat. No. 4,483,833, as well as various compound solutions described in U.S. Pat. No. 4,483,833 and according to the definition of document WO-2009/1,105,586: a 50 wt. % N-(2-hydroxyethyl)-pyrolidine solution, a 45 wt. % N-(2-hydroxyethyl)-piperidine solution and a 45 wt. % N-methyl-2-hydroxyethyl-piperidine solution.

For each test, the CO₂ stream absorbed by the aqueous solution is measured in a closed reactor of Lewis cell type. 200 g solution are fed into the closed reactor whose temperature is set at 50° C. Four successive carbon oxysulfide injections are carried out at a pressure from 100 to 200 mbar in the vapour phase of the 200 cm³-volume reactor. The gas phase and the liquid phase are stirred at 100 rpm and entirely characterized from the hydrodynamic point of view. For each injection, the carbon dioxide absorption rate is measured through pressure variation in the gas phase. A global transfer coefficient Kg is thus determined using a mean of the results obtained for the 4 injections.

The results obtained are shown in Table 2 in relative absorption rate by comparison with the 47 wt. % methyldiethanolamine reference formulation, this relative absorption rate being defined by the ratio of the global transfer coefficient of the solvent to the global transfer coefficient of the reference formulation.

TABLE 2

| | | CO2 relative |
|---|---|---|
| | Concentration | absorption |
| Compound | (wt. %) | rate at 40° C. |
| MDEA | 47 | 1.00 |
| N-methyl-4-hydroxypiperidine | 50 | 0.92 |
| (according to the invention) | | |
| N-methyl-2-hydroxymethylpiperidine | 50 | 1.73 |
| (prior art) | | |
| N-(2-hydroxyethyl)-pyrolidine | 50 | 3.25 |
| (prior art) | | |
| N-(2-hydroxyethyl)-piperidine | 45 | 1.62 |
| (prior art) | | |
| N-methyl-2-hydroxyethylpiperidine | 45 | 1.59 |
| (prior art) | | |

These results highlight, under the test conditions, a slower CO₂ absorption rate with the N-methyl-4-hydroxypiperidine-based solution according to the invention in relation to the reference MDEA formulation, unlike the other molecules mentioned in the prior art. It thus appears that the exemplified molecule according to the invention exhibits a particular and improved interest in the case of selective deacidizing wherein the CO₂ absorption kinetics is to be limited.

### Example 3

### CO₂ Absorption Rate of an Activated Formulation

The CO₂ absorption rate of an absorbent solution containing 39 wt. % methyldiethanolamine and 6.7 wt. % piperazine in water is compared with that of an absorbent solution according to the invention containing 39 wt. % N-methyl-4-hydroxypiperidine and 6.7 wt. % piperazine in water.

In each test, a CO₂-containing gas is contacted with the absorbent liquid in a vertical falling film reactor provided, in the upper part thereof, with a gas outlet and a liquid inlet and, in the lower part thereof, with a gas inlet and a liquid outlet. A gas containing 10% CO₂ and 90% nitrogen is injected through the gas inlet at a flow rate ranging between 30 and 50 Nl/h, and the absorbent liquid is fed to the liquid inlet at a flow rate of 0.5 l/h. A CO₂-depleted gas is discharged through the gas outlet and the CO₂-enriched liquid is discharged through the liquid outlet.

The absolute pressure and the temperature at the liquid outlet are 1 bar and 40° C. respectively.

For each test, the CO₂ stream absorbed between the gas inlet and outlet is measured as a function of the incoming gas flow rate: for each gas flow rate setpoint: 30-35-40-45-50 Nl/h, the incoming and outgoing gas is analyzed using techniques measuring the infrared radiation absorption in the gas phase so as to determine the CO₂ content thereof. The global transfer coefficient Kg characterizing the absorption rate of the absorbent liquid is deduced from all these measurements by carrying out two increase-decrease cycles over the entire range of flow rates.

The operating conditions specific to each test and the results obtained are given in Table 3.

TABLE 3

| Composition of the aqueous absorbent solution | | | | |
|---|---|---|---|---|
| | | | | CO₂ |
| Tertiary amine | | Activator | | relative |
| | Concentra- | | Concentration | absorption |
| Nature | tion (wt. %) | Nature | (wt. %) | rate |
| MDEA | 39 | Piperazine | 6.7 | 1 |
| N-methyl-4- | 39 | Piperazine | 6.7 | 1.24 |
| hydroxypiperidine | | | | |
| (according to the | | | | |
| invention) | | | | |

The results shown in Table 3 highlight the improved CO₂ absorption rate of the absorbent solutions according to the invention in relation to those of the reference absorbent solution containing an MDEA-piperazine mixture known to the person skilled in the art.

### Example 4

### Capture Capacity of N-Methyl-4-Hydroxypiperidine

The CO₂ capture capacity performances of the N-methyl-4-hydroxypiperidine according to the invention are notably compared with those of a 30 wt. % MonoEthanolAmine aqueous solution that is the reference solvent in a capture application for the CO₂ contained in post-combustion fumes. They are also compared with those of an N-methyl-2-hydroxymethylpiperidine aqueous solution mentioned in U.S. Pat. No. 4,405,582 containing the same percentage by weight of tertiary diamine and piperazine. An absorption test is carried out on aqueous amine solutions in a perfectly stirred closed reactor whose temperature is controlled by a regulation system. For each solution, absorption is conducted in a 50-cm³ liquid volume by injections of pure CO₂ from a reserve. The solvent solution is first evacuated prior to any CO₂ injection. The pressure of the gas phase in the reactor is measured and a global material balance on the gas phase allows to measure the solvent loading α=nbr moles of acid gas/nbr moles of amine.

By way of example, the loadings (α=nbr moles of acid gas/nbr moles of amine) obtained at 40° C. for various CO₂ partial pressures are compared in Table 4 between a 30 wt. % N-methyl-4-hydroxypiperidine aqueous solution according to the invention, a 30 wt. % N-methyl-2-hydroxymethylpiperidine aqueous solution described in document WO-2009/1,105,586 and a 30 wt. % MonoEthanolAmine aqueous solution for a post-combustion CO₂ capture application.

Switching from a quantity for the loading obtained in the laboratory to a quantity characteristic of the method requires some calculations that are explained below for the application concerned.

In the case of a post-combustion CO₂ capture application, the CO₂ partial pressures in the effluent to be treated are typically 0.1 bar with a temperature of 40° C., and a 90% acid gas abatement is sought. The cyclic capacity Δα_{PC} expressed in moles of CO₂ per kg of solvent is calculated, considering that the solvent reaches its maximum thermodynamic capacity at the absorption column bottom α_{PPCO2=0.1 bar} and must at least be regenerated below its thermodynamic capacity under the column top conditions α_{PPCO2=0.01 bar} to achieve a 90% CO₂ abatement.

Δα_{PC}=(α_{PPCO2=0.1 bar}−α_{PPCO2=0.01 bar})·[A]·10/M

where [A] is the amine concentration expressed in wt. % and M the molar mass of the amine in g/mol, α_{PPCO2=0.1 bar} and α_{PPCO2=0.01 bar} are the loadings (mole CO₂/mole amine) of the solvent at equilibrium with a CO₂ partial pressure of 0.1 bar and 0.01 bar respectively.

The reaction enthalpy can be obtained by calculation from several CO₂ absorption isotherms by applying Van′t Hoff's law.

TABLE 4

| | | | Loading | | | |
|---|---|---|---|---|---|---|
| | | | a = n_{CO2}/nₐₘᵢₙₑ | | Δa_{PC} | |
| | | | P_{PCO2} = | P_{PCO2} = | (mol_{CO2}/kg | ΔH |
| Generic name | Concentration | T (° C.) | 0.1 bar | 0.01 bar | solvent) | (kJ/mol_{CO2}) |
| MEA | 30 wt. % | 40 | 0.52 | 0.44 | 0.38 | 92 |
| N-methyl-2- | 30 wt. % | 40 | 0.71 | 0.28 | 1.00 | 64 |
| hydroxymethylpiperidine | | | | | | |
| (prior art) | | | | | | |
| N-methyl-4-hydroxypiperidine | 30 wt. % | 40 | 0.56 | 0.13 | 1.12 | 57 |
| (according to the invention) | | | | | | |

For a post-combustion fumes capture application where the CO₂ partial pressure in the effluent to be treated is 0.1 bar, this example illustrates the higher cyclic capacity obtained using an N-methyl-4-hydroxypiperidine absorbent solution according to the invention, comprising 30 wt. % molecules allowing to reach 90% abatement at the absorber outlet. In this application where the energy associated with the solution regeneration is critical, it can be noted that the amine according to the invention allows to obtain a much better compromise than MEA in terms of cyclic capacity and reaction enthalpy. A gain in terms of cyclic capacity and reaction enthalpy of the N-methyl-4-hydroxypiperidine according to the invention is also observed in relation to the N-methyl-2-hydroxymethylpiperidine described in document WO-2009/1,105,586.

### Example 5

### CO₂ Capture Capacity of Piperazine-Activated N-Methyl-4-Hydroxypiperidine Solutions. Application to Post-Combustion Fumes Treatment

The CO₂ capture capacity performances of an N-methyl-4-hydroxypiperidine aqueous solution according to the invention in admixture with piperazine are notably compared with those of a 30 wt. % monoethanolamine aqueous solution, which is the reference solvent in a capture application for the CO₂ contained in post-combustion fumes. They are also compared with those of an N-methyl-2-hydroxymethylpiperidine aqueous solution described in document WO-2009/1,105,586 and containing the same percentage by weight of tertiary amine and piperazine.

The absorption tests are carried out as described in the previous example.

By way of example, Table 5 compares the loadings (α=nbr moles of acid gas/nbr moles of amine) obtained at 40° C. for various CO₂ partial pressures between a 39 wt. % N-methyl-4-hydroxypiperidine absorbent solution according to the invention containing 6.7 wt. % piperazine to accelerate the post-combustion CO₂ capture kinetics, a 30 wt. % monoethanolamine absorbent solution and a 39 wt. % N-methyl-2-hydroxymethylpiperidine absorbent solution containing 6.7 wt. % piperazine.

The floadings α_{PPCO2=0.1 bar} and α_{PPCO2=1 bar} are as defined in the previous example.

The cyclic capacity Δα_{PC} expressed in moles of CO₂ per kg of solvent is calculated as in Example 2:

Δα_{PC}=(α_{PPCO2=0,1 bar}−α_{PPCO2=0.01 bar})·[A]·10/M

where [A] is the total amine concentration expressed in wt. % and, in the case of amine mixtures, M is the average molar mass of the amine mixture in g/mol:

M=[A_{T}]/([A_{T}]/M_{AT}+[PZ]/M_{PZ}),

where [A_{T}], [PZ] are the tertiary amine and piperazine concentrations respectively, expressed in wt. %, M_{AT} and M_{PZ} are the tertiary amine and piperazine molar masses respectively, expressed in mol/kg.

TABLE 5

| | | Loading | | |
|---|---|---|---|---|
| | | α = n_{CO2}/nₐₘᵢₙₑ | | Δα_{PC} |
| | | P_{PCO2} = | P_{PCO2} = | (mol_{CO2}/kg |
| Solvent | T (° C.) | 0.1 bar | 0.01 bar | solvent) |
| 30 wt. % MEA | 40 | 0.52 | 0.44 | 0.38 |
| 39 wt. % N-methyl-2-hydroxymethylpiperidine | 40 | 0.61 | 0.33 | 1.05 |
| (described in document WO-2009/1,105,586) + | | | | |
| 6.7 wt. % piperazine | | | | |
| 39 wt. % N-methyl-4-hydroxypiperidine | 40 | 0.49 | 0.24 | 1.08 |
| (according to the invention) + 6.7 wt. % | | | | |
| piperazine | | | | |

For a post-combustion fumes capture application where the CO₂ partial pressure in the effluent to be treated is 0.1 bar, this example illustrates the higher cyclic capacity obtained using the absorbent solution according to the invention, comprising 39 wt. % N-methyl-4-hydroxypiperidine according to the invention and 6.7 wt. % piperazine allowing to reach 90% abatement at the absorber outlet in relation to the 30 wt. % MEA.

A gain in terms of cyclic capacity of the formulation according to the invention is also observed in relation to the same percentage by weight of N-methyl-2-hydroxymethylpiperidine described in document WO-2009/1,105,586 and containing the same percentage by weight of piperazine.

### Example 6

### CO₂ Absorption Capacity of Piperazine-Activated N-Methyl-4-Hydroxypiperidine Solutions. Application to Decarbonation Treatment of Natural Gas

The CO₂ absorption capacity performances of an N-methyl-4-hydroxypiperidine aqueous solution according to the invention in admixture with piperazine are notably compared with those of a methyldiethanolamine aqueous solution in admixture with piperazine containing the same percentage by weight of tertiary amine and piperazine, known to the person skilled in the art for removing CO₂ in natural gas treatment. They are also compared with those of an N-methyl-2-hydroxymethylpiperidine aqueous solution described in document WO-2009/1,105,586 and containing the same percentage by weight of tertiary amine and piperazine.

The absorption tests are carried out as described in the previous example.

By way of example, Table 6 compares the loadings (α=nbr moles of acid gas/nbr moles of amine) obtained at 40° C. for a CO₂ partial pressure of 3 bars between a 39 wt. % N-methyl-4-hydroxypiperidine absorbent solution according to the invention containing 6.7 wt. % piperazine, a 39 wt. % methyldiethanolamine absorbent solution containing 6.7 wt. % piperazine and a 39 wt. % N-methyl-2-hydroxymethylpiperidine absorbent solution containing 6.7 wt. % piperazine.

In the case of application in a decarbonation treatment of natural gas, the CO₂ partial pressures are typically centered between 1 and 10 bars with a temperature of 40° C., and it is desired to remove nearly all of the CO₂ with a view to natural gas liquefaction. To compare the various solvents, the maximum cyclic capacity Δα_{LNG,max} expressed in moles of CO₂ per kg of solvent is calculated, considering that the solvent reaches its maximum thermodynamic capacity at the absorption column bottom α_{PPCO2=3 bar} and it is totally regenerated under the column top conditions.

Δα_{LNG,max}=(α_{PPCO2=3 bar})·[A]·10/M

where [A] is the total amine concentration expressed in wt. % and, in the case of amine mixtures, M is the average molar mass of the amine mixture in g/mol:

M=[A_{T}]/([A_{T}]/M_{AT}+[PZ]/M_{PZ}),

where [A_{T}], [PZ] are the tertiary amine and piperazine concentrations respectively, expressed in wt. %, M_{AT} and M_{PZ} are the tertiary amine and piperazine molar masses respectively, expressed in mol/kg.

α_{PPCO2=3 bar} is the loading (mole CO₂/mole amine) of the solvent at equilibrium with a CO₂ partial pressure of 3 bars.

TABLE 6

| | | | Δα_{LNG,max} |
|---|---|---|---|
| | | α_{PPCO2=3 bar} | (mol_{CO2}/ |
| | T | (mol_{CO2}/mol | kg |
| Solvent | (° C.) | amine) | Solvent) |
| 39 wt. % MDEA + 6.7 wt. % | 40 | 0.88 | 3.57 |
| piperazine | | | |
| 39 wt. % N-methyl-2- | 40 | 0.93 | 3.55 |
| hydroxymethylpiperidine (described | | | |
| in document WO-2009/1,105,586) + | | | |
| 6.7 wt. % piperazine | | | |
| 39 wt. % N-methyl-4-hydroxypiperidine | 40 | 0.91 | 3.80 |
| (according to the invention) + 6.7 wt. % | | | |
| piperazine | | | |

For application of a total decarbonation treatment of natural gas, this example illustrates the higher cyclic capacity obtained using the absorbent solution according to the invention, comprising 39 wt. % N-methyl-4-hydroxypiperidine according to the invention and 6.7 wt. % piperazine in relation to the reference formulation containing 39 wt. % MDEA and 6.7 wt. % piperazine.

A gain in terms of cyclic capacity of the formulation according to the invention is also observed in relation to the same percentage by weight of N-methyl-2-hydroxymethylpiperidine described in document WO-2009/1,105,586 and containing the same percentage by weight of piperazine.

### Example 7

### Stability of an Amine Solution According to the Invention

The amines used according to the invention have the specific feature of being particularly resistant to the degradations that may occur in a deacidizing unit.

A degradation test is carried out on aqueous amine solutions in a closed reactor whose temperature is controlled by a regulation system. For each solution, the test is carried out in a 50-cm³ liquid volume injected in the reactor. The solvent solution is first evacuated prior to any gas injection and the reactor is then placed in a heating shell at the setpoint temperature and subjected to magnetic stirring. The concerned gas is then injected at the desired partial pressure. This pressure is added to the initial pressure due to the vapour pressure of the aqueous amine solution. Various degradation conditions are tested:

degradation in CO₂: CO₂ is injected so as to reach a partial pressure of 20 bars,

degradation in O₂: air is injected at a partial pressure of 20 bars, which gives an oxygen partial pressure of 4.2 bars.

Table 7 gives the degradation rate TD, through degradation in CO₂, of the N-methyl-4-hydroxymethylpiperidine according to the invention and of the N-methyl-2-hydroxymethylpiperidine described in document WO-2009/1,105,586, as well as MEA as the reference amine, for a duration of 15 days, defined by the equation hereafter:

$$TD ( \% ) = \frac{[ A ] - [ A ] °}{[ A ] °}$$

where [A] is the compound concentration in the degraded sample and [A]° is the compound concentration in the non-degraded solution. Concentrations [A] and [A]° are determined by gas chromatography.

TABLE 7

| | | | PP_{CO2} = |
|---|---|---|---|
| | | | 20 bar |
| Amine | Concentration | T (° C.) | TD (%) |
| MEA | 30 wt. % | 140 | 42% |
| N-methyl-2-hydroxymethylpiperidine | 50 wt. % | 140 | 11% |
| (described in document WO- | | | |
| 2009/1,105,586) | | | |
| N-methyl-4-hydroxymethylpiperidine | 50 wt. % | 140 | 1% |
| (according to the invention) | | | |

Table 8 gives the degradation rate TD, through degradation in O₂, of the N-methyl-4-hydroxymethylpiperidine according to the invention, as well as MEA as the reference amine, for a duration of 15 days, defined as above:

TABLE 8

| | | | PP_{O2} = 4.2 bar |
|---|---|---|---|
| Amine | Concentration | T (° C.) | TD (%) |
| MEA | 30 wt. % | 140 | 21% |
| N-methyl-4- | 50 wt. % | 140 | 2% |
| hydroxymethylpiperidine | | | |
| (according to the invention) | | | |

Table 9 gives the degradation rate TD, through degradation in CO₂, of the N-methyl-4-hydroxymethylpiperidine according to the invention and of the piperazine in admixture therewith in an absorbent solution, as well as the MDEA used as the reference amine, and of the piperazine in admixture therewith in another absorbent solution, for a duration of 15 days, the degradation rate of each amine being defined as above:

TABLE 9

| | | PP_{CO2} = 4.2 bar | |
|---|---|---|---|
| | | TD | TD |
| | | tertiary amine | piperazine |
| Absorbent solution | T (° C.) | (%) | (%) |
| 39% MDEA + 6.7% piperazine | 140 | 13% | 43% |
| 39% N-methyl-4- | 140 | 5% | 8% |
| hydroxymethylpiperidine + 6.7% | | | |
| piperazine | | | |

This example shows that using compounds according to the invention as the amine in an absorbent solution allows to obtain a low degradation rate in relation to the amine-based absorbent solutions of the prior art (monoethanolamine and N-methyl-2-hydroxymethylpiperidine described in document WO-2009/1,105,586).

In admixture with piperazine, it also shows a lower degradation rate of the compounds according to the invention and of the piperazine in admixture therewith, in relation to the methyldiethanolamine in admixture with piperazine.

It is therefore possible to regenerate the absorbent solution at higher temperature and thus to obtain an acid gas at higher pressure. This is particularly interesting in case of post-combustion CO₂ capture or in applications in a decarbonation treatment of natural gas where the acid gas must be compressed to be liquefied prior to reinjection.

1. An absorbent solution for removing acid compounds contained in a gaseous effluent, comprising:
a—water,
b—at least one compound selected from the N-alkyl-3-hydroxypiperidine and N-alkyl-4-hydroxypiperidine group with general formula (I): 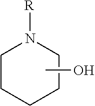
wherein the hydroxyl radical can be in position 3 or in position 4 with respect to the nitrogen atom of the piperidine ring, and R is an alkyl radical containing one to six carbon atoms, preferably one to three carbon atoms.

2. An absorbent solution as claimed in claim 1, wherein the compound is selected from among the following compounds:

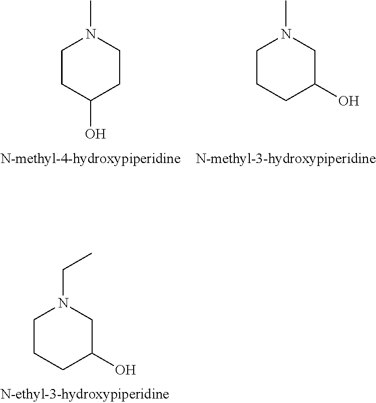

3. An absorbent solution as claimed in claim 1, comprising between 10 and 90 wt. % of said compound, preferably between 20 and 60 wt. %, more preferably between 25 and 50 wt. %.

4. An absorbent solution as claimed in claim 1, comprising between 10 and 90 wt. % of said compound, preferably between 20 and 60 wt. %, more preferably between 25 and 50 wt. %.

5. An absorbent solution as claimed in claim 1, comprising an additional amine, said additional amine being a tertiary amine such as methyldiethanolamine, or a secondary amine having two tertiary carbons at nitrogen alpha position, or a secondary amine having at least one quaternary carbon at nitrogen alpha position.

6. An absorbent solution as claimed in claim 5, comprising between 10 and 90 wt. % of said additional amine, preferably between 10 and 50 wt. %, more preferably between 10 and 30 wt. %.

7. An absorbent solution as claimed in claim 1, comprising a compound containing at least one primary or secondary amine function.

8. An absorbent solution as claimed in claim 7, having a concentration of up to 30 wt. % of said compound, preferably below 15 wt. %, preferably below 10 wt. % and of at least 0.5 wt. %.

9. An absorbent solution as claimed in claim 7, having a concentration of at least 0.5 wt. % of said compound.

10. An absorbent solution as claimed in claim 7, wherein said compound is selected from among:
monoethanolamine,
N-butylethanolamine,
aminoethylethanolamine,
diglycolamine,
piperazine,
1-methylpiperazine,
2-methylpiperazine,
N-(2-hydroxyethyl)piperazine,
N-(2-aminoethyl)piperazine,
morpholine,
3-(methylamino)propylamine,
1,6-hexanediamine and all the diversely N-alkylated derivatives thereof such as, for example, N,N′-dimethyl-1,6-hexanediamine, N-methyl-1,6-hexanediamine or N,N′,N′-trimethyl-1,6-hexanediamine.

11. An absorbent solution as claimed in claim 1, comprising a physical solvent selected from among methanol and sulfolane.

12. A method for removing acid compounds contained in a gaseous effluent, wherein an acid compound absorption stage is carried out by contacting the effluent with an absorbent solution as claimed in claim 1.

13. A method as claimed in claim 12, wherein the acid compound absorption stage is carried out at a pressure ranging between 1 bar and 120 bars, and at a temperature ranging between 20° C. and 100° C.

14. A method as claimed in claim 12 wherein, after the absorption stage, a gaseous effluent depleted in acid compounds and an absorbent solution laden with acid compounds are obtained, and at least one stage of regenerating the absorbent solution laden with acid compounds is performed.

15. A method as claimed in claim 14, wherein the regeneration stage is carried out at a pressure ranging between 1 bar and 10 bars, and at a temperature ranging between 100° C. and 180° C.

16. A method as claimed in claim 12, wherein the gaseous effluent is selected from among natural gas, syngas, combustion fumes, refinery gas, acid gas from amine units, Claus tail gas, biomass fermentation gas, cement plant gas and incinerator fumes.

17. A method as claimed in claim 12, implemented for selective H₂S removal from a gaseous effluent comprising H₂S and CO₂.

18. An absorbent solution as claimed in claim 2, comprising between 10 and 90 wt. % of said compound, preferably between 20 and 60 wt. %, more preferably between 25 and 50 wt. %.

19. An absorbent solution as claimed in claim 2, comprising between 10 and 90 wt. % of said compound, preferably between 20 and 60 wt. %, more preferably between 25 and 50 wt. %.

20. An absorbent solution as claimed in claim 3, comprising between 10 and 90 wt. % of said compound, preferably between 20 and 60 wt. %, more preferably between 25 and 50 wt. %.
